(19) United States
(12) Patent Application Publication
(10) Pub. No.: US 2016/0142543 A1
(43) Pub. Date: May 19, 2016

(54) METHOD AND DEVICE FOR COMMUNICATING

(71) Applicants: Jonas, Carl MOSSLER, Mannheim (DE); Axel GANTER, Mannheim (DE)

(72) Inventors: Jonas Carl Mossler, Mannheim (DE); Axel Ganter, Mannheim (DE)

(21) Appl. No.: 14/898,273

(22) PCT Filed: Jun. 16, 2014
(86) PCT No.: PCT/DE2014/200262

§ 371 Date: Dec. 28, 2015

(30) Foreign Application Priority Data
Jun. 14, 2013 (DE) 10 2013 211 146.0

(51) Int. Cl. H04M 3/51

(52) U.S. Cl. CPC H04M 3/5166

(57) ABSTRACT

The invention relates to a method and device for communicating, comprising a terminal provided for a user, comprising a display, optionally a camera and a voice input/output unit. Said terminal can be integrated into a network to be part of the local network, can be communicate with a central unit and can be controlled by means of said central unit. Said central unit communicates directly and/or indirectly between the user and any third parties.

### CROSS REFERENCE TO RELATED APPLICATIONS

This application is a national stage application, filed under 35 U.S.C. §371, of International Application No. PCT/DE2014/200262, filed Jun. 16, 2014, which claims priority to German Application No. 10 2013 211 146.0, filed Jun. 14, 2013, the contents of both of which as are hereby incorporated by reference in their entirety.

### BACKGROUND

The present invention relates to a method and a device for communication with a terminal available to a user, which comprises a display, a camera if necessary, and a speech input/output unit, wherein the terminal may be integrated into a network for participation therein, may communicate with a control center, and is controllable via the control center, and wherein the control center directly and/or indirectly manages the communication between the user and any third party.

Very generally, the present invention concerns a process and a device for communication, as this has been sufficiently known from practical use. The type of communication under discussion here routinely takes place via the internet.

Known methods and devices are disadvantageous in the sense that the communication by inexperienced persons, in particular older people, is difficult to accomplish, namely due to lack of pertinent knowledge in the area of using computer-specific equipment. In particular, older people often fear the assumed complexity of the technology, and for this reason, their access to modern communication technologies and other computer-based equipment and services remains blocked.

### BRIEF SUMMARY

The underlying object of the present invention is therefore to simplify communication, particularly via the internet, and to make it possible for inexpert and older people.

According to the invention, the preceding problem is solved by the features of coordinate Claims 1 and 10, namely by a method and also by a device which simplify communication.

From an invention standpoint, it has been known that it is particularly advantageous to make the possibility of simplified communication available to the user, namely through a very simple terminal for data communication, which in the simplest case comprises only a display in addition to the technical equipment required for communication. If necessary, the terminal may have an control panel or control button, a camera, and/or a speech input/output unit. The terminal may be integrated into a network for participation therein, for example on the internet. Using the terminal, a connection to a control center is established, with which the user may communicate. The control center may in turn communicate with third parties and thus establishes the communication between the user and the third parties, which is otherwise achievable in a complicated way via the internet. In the other direction, communication on the part of third parties is carried out with the user via the control center, wherein the control center controls the terminal of the user, may manage speech, text, and/or image information for the user, if necessary taking additional speech information as a basis, so that the terminal functions on the one hand as an input device for communication with the control center, and on the other hand as an output device for information.

The communication with any third party may be, for example, text, speech, and/or video telephony. It is also conceivable to call up and output text, speech, and image information from the offerings by third parties, preferably via the internet or from a storage medium which may be reached via the network.

In other words, the user needs only to establish contact to the control center via the terminal in order to be able to participate in modern communication or communication technology.

Consequently, using the method and the device according to the invention, a method and a device are created which simplify communication, in particular via the internet, and make it possible for inexpert and older people.

The terminal may advantageously be actuated via a single operating element, preferably via a control button, and the control center may thereby be contacted. A housing element is conceivable, comprising a single control button with only one single actuation process—for example pressing the actuation button—in order to contact the control center, and thus obtain the assistance of the control center. The complexity for the user is reduced to a minimum in this manner. It is likewise conceivable to integrate the operating element into a wristwatch, a wristband, a pendant, a house phone or mobile telephone, or any other electric/electronic device, and/or a motor vehicle. Smartphones and other systems may be equipped via a corresponding application program in order to function as the terminal or operating element.

It is likewise conceivable that the terminal and/or the operating element has/have a signal generator in order to signal the user that information is available for him/her—of whichever type—and may be called up by actuation of the operating element. The signal generator may, for example, have a light element which flashes or illuminates.

It is of especial advantage if the communication takes place between the user and the control center using speech. If the terminal is activated, the control center is contacted, and a connection is established between the user and the control center, then the user may present his/her requests orally. A speech output for the control center for reciprocal dialog is also conceivable, for example, if a speech input from the user is not recognized.

The communication between the user and the control center may therefore take place via the speech input and output unit of the terminal and/or via telephone. For example, the user may contact the control center via the terminal or via the operating element and is subsequently called telephonically by the control center in order to effect a speech input or, if necessary, to enter into reciprocal dialog with the control center.

In an especially advantageous way, the recognition of the speech input of the user takes place via an automated speech recognition mechanism, and control commands may be executed automatically. Corresponding speech recognition systems are sufficiently familiar.

It is, however, problematic with regard to known speech controllers, that they are difficult to operate due to extremely limited and impersonal speech models. If the speech recognition fails, the desired command may not be executed, or the user must execute the command him or herself. It is exactly these types of complications in particular that frighten inexpert and older people away from using devices and systems of this type.

In the case of the failure of an automated speech recognition mechanism, this problem may be prevented advantageously by a hybrid speech controller. In this case, a human operator, preferably at a call center, is added to the connection, and then, if necessary, enters into dialog with the user and manually enters the corresponding control command. This guarantees to the user the assurance that his/her requests are understood in each case and a command is executed from his/her speech input. The person or the operator thus functions as a fallback solution and enables the highest reliability of the system and convenience.

Ideally, a speech recognition system continuously learns new speech models through manual input and links these to corresponding control commands.

The information, which the user requests and is presented to the user, may be any information, such as text and/or speech and/or image information, which is offered by third-party network participants or may be called up in available storage media. Basically, the service of the control center may be understood as a type of concierge service or also as a personal assistant service. Many other applications and service areas are conceivable, such as office assistance, reminder services, translation, research, advice, etc. If the automated command execution fails, an operator may step in as an intermediary and, if necessary, query additional specialist agents regarding specific topics. For instance, the operator may query a translator in the case of an error with an automated translation, or a medical advisor in a scenario involving telemedicine. Using mobile telephones and/or GPS, the method according to the invention may also be used independent of location.

It is especially advantageous if the terminal is able to be coupled wirelessly to any household, entertainment, and communication devices, in particular electronic devices, so that parameters regarding these may be transmitted to the control center. In this way, the devices may be monitored and/or controlled via the control center. For example, this may be the television, through which text, image, sound, and other information is presented to the user. Likewise, any third parties may transmit a digital photo album to the user and he/she may view the photos on the television.

Household devices and household equipment may also be maintained and readings may be taken by third parties via the control center. In this manner, the terminal may function as a gateway for readings of household technology and sensor data in the field of ambient assisted living technology; third parties may obtain access to these readings via the central control or the readings may be transmitted to them. Intelligent remote control is likewise conceivable. The possibilities are manifold and practically unlimited, without requiring the user to have specialized knowledge about the use of these types of devices and of the network. However, it is important that the method according to the invention is not limited to remote maintenance and remote control systems, but rather that it instead enables bidirectional communication.

A device for communication with a terminal available to a user, in particular using the method according to one of Claims 1 through 9, is claimed in Claim 10. It has a terminal for data communication, a display, a camera if necessary and a speech input/output unit, a control center with a processor, means for data storage, and a data input/output unit, in particular with a display, wherein the control center may communicate with the user(s), preferably via the internet, and wherein the control center may directly and/or indirectly establish communication via the internet between any third party participants on the internet and the user, in such a way that the user preferably communicates with the third parties via the control center.

There are various options for formulating and further developing the teaching of the present invention in an advantageous manner. Reference to this is made on the one hand to the claims subordinate to Claim 1 and on the other hand to the subsequent detailed explanation of a preferred embodiment of the invention by means of the drawing. Generally preferred embodiments and developments of the teaching are also explained in connection with the explanation of the preferred embodiment of the invention by means of the drawing.

### BRIEF DESCRIPTION OF THE FIGURES

FIG. 1 shows in a schematic representation the functional principle of the method according to the invention together with the device according to the invention, wherein the device is a system,

FIG. 2 shows in a schematic representation the progression of a conventional speech recognition system,

FIG. 3 shows in a schematic representation the progression of a hybrid speech recognition system.

### DETAILED DESCRIPTION OF VARIOUS EMBODIMENTS

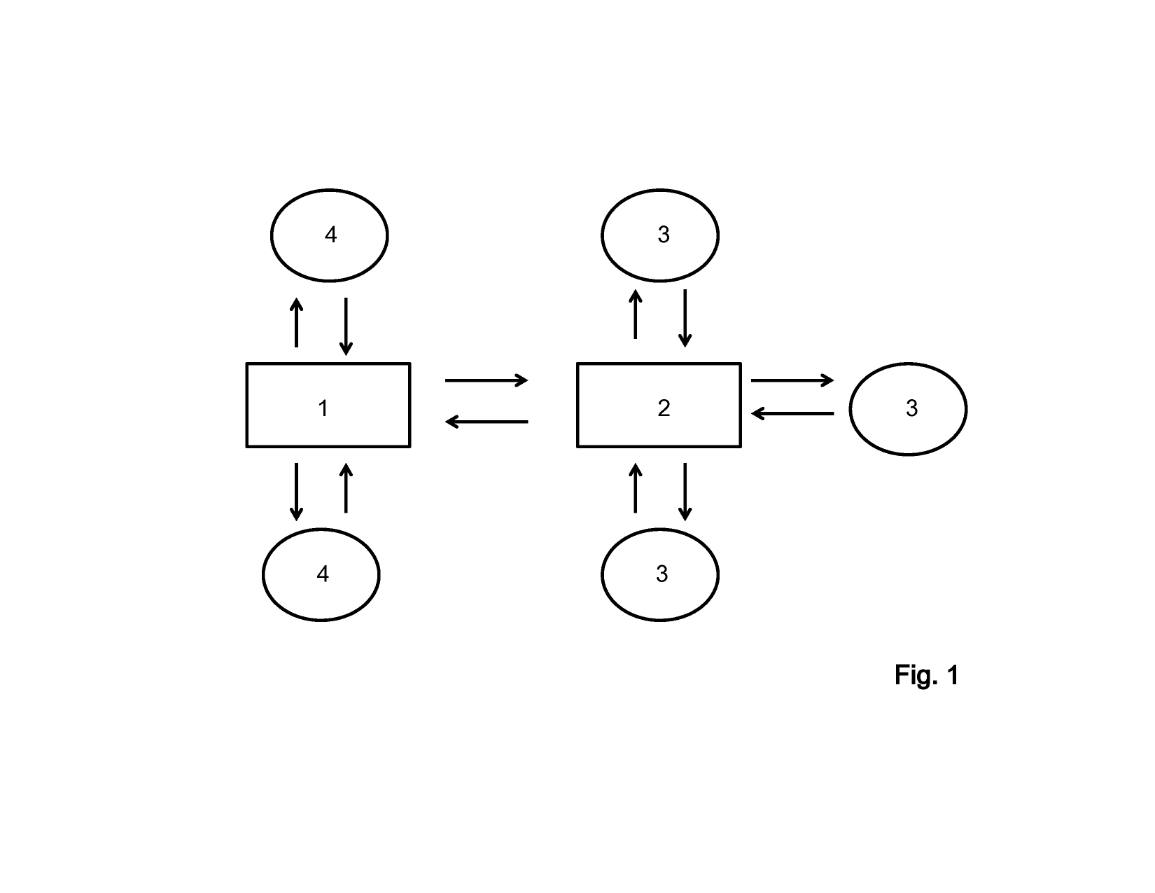

FIG. 1 shows in a schematic representation the functional principle of the method according to the invention together with the device according to the invention. A terminal 1, which is logged in to the internet, for example via WLAN, is made available to a user. Terminal 1 is a highly reduced terminal with a display and a speech input and output unit. By means of an operating element in the form of a housing element with a single control button, the user may contact the central control 2, whereupon central control calls the user via telephone in order to learn his/her requests via speech. Communication via the speech input and output unit on terminal 1 is likewise conceivable. It is essential that the user must only press the operating button in order to contact the central control, which thereupon calls him/her and according to his/her desire may control the devices, display offers from third parties, and/or carry out additional services.

The operating element, which has a single control button, further comprises a light element, for example integrated into the control button. If the control center has a request directed at the user, for example regarding a missed call, a received email, the result of a service, or maintenance on one of the devices linked to the terminal is due, this is then signaled to the user by illumination or flashing of the light element. The user may—whenever he/she would like—contact the control center by pressing the control button in order to learn what this is, and, if necessary, receive the presentation of results.

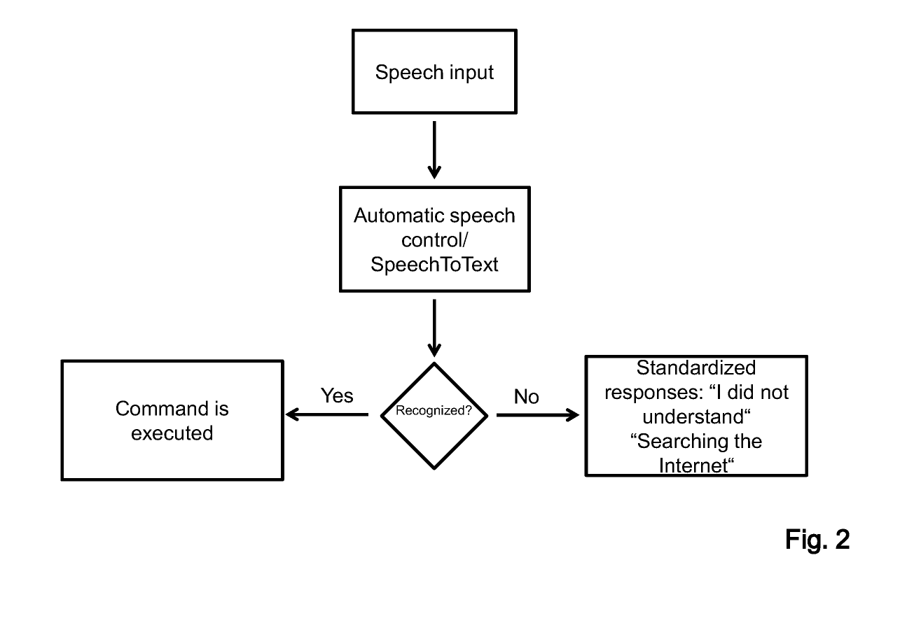

Control center 2 has an automated speech recognition mechanism and may thus execute control commands automatically. However, as is indicated in FIG. 2, conventional speech controllers fail as soon as a speech command is not recognized. An error message most often follows, for example, in the form of a standard response like “I did not understand that”. The user is left with no other option than to repeat the speech input until it is recognized, or to execute the command manually him/herself. This is particularly to be avoided for inexpert and older people.

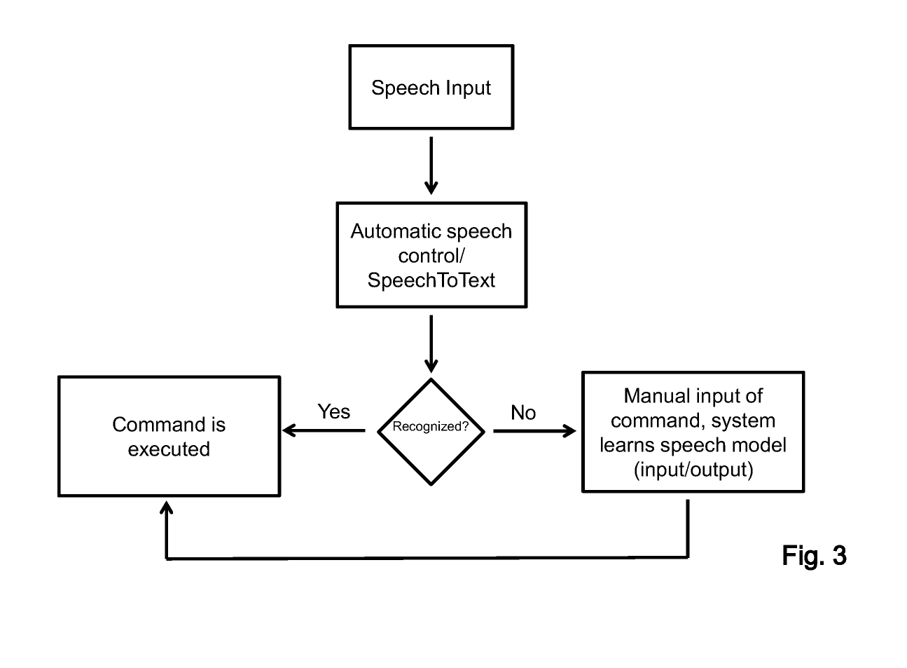

FIG. 3 shows the flowchart of a hybrid speech recognition, in which the automated speech recognition is connected to a human operator. In the case that the request of the user is not recognized by the automated speech recognition, a human operator is added in a call center, who manually enters the corresponding command, and, if necessary, enters into dialog with the user. In this way, the speech recognition system of control center 2 continuously learns new speech models. Also, storing or learning of dialects and unclear pronunciation may be collected to a certain degree in this way, or at least now be recognized. It is essential, however, that the user be able to rely on the control center and have no fear that the system will not understand, and thus not function.

The user communicates exclusively with the control center, which in turn may communicate with any third party 3 (FIG. 1). The user obtains any information exclusively via control center 2, displayed via terminal 1, or via the telephony thus made possible or via other linked devices In this manner, the user may, for example, allow him/herself to be connected with a third party and a video chat may be established by control center 2. Conversely, third parties may be connected to the user by control center 2. The user may also have contents of websites or search results regarding a specific topic displayed on his/her display, have them play on his/her terminal, or even be read aloud. Further services on the part of control center 2 are also conceivable, such as, for example, the translation of texts and speech files or the writing of texts. Thus, the user might dictate an email and follow the text in real time on his/her display. In this way, modern communication technologies are accessible to an untrained or older person.

It is additionally possible that terminal 1 is linked to any electric/electronic devices 4 in the household, preferably via an infrared interface or via radio, so that control center 2, directly or in turn via third parties 3, may control, inspect, regulate any devices, or even carry out troubleshooting and/or maintenance.

In summary, it is stated that using the method according to the invention and the device according to the invention or the system according to the invention, a simplified option is described with which third parties without computer skills may take advantage of the internet without mastering the complex applications there. This occurs through the interposition of a control center which, in addition to an automated speech recognition, is preferably occupied by a human being in the sense of a call center so that the user communicates exclusively with control center 2 via terminal 1, and control center 2 establishes, maintains, or searches for any connection to third parties 3, or also presents the results of other services to the user. A very simple option for communication with the people in the user's environment is provided to the user by using the most modern technologies without requiring mastery of them.

With respect to further advantageous embodiments of the device according to the invention, reference is made to the general part of the description and also to the appended claims to avoid repetitions.

Finally, reference is explicitly made to the fact that the previously described embodiment serves merely as an explanation of the claimed teaching; however this is not limited to the embodiment.

### REFERENCE LIST

1 Terminal
2 Control center
3 Third party
4 Electrical/electronic device

1-10. (canceled)

11. A method for communication with a terminal available to a user and comprising a display, if necessary a camera and a speech input/output unit, wherein the terminal is integrated into a network for participation therein and communicates with a control center and is controllable via the control center, wherein the control center manages a communication between the user and any third party, wherein the communication between the user and the control center is carried out via speech, wherein, in the event of failure of an automated speech recognition mechanism, a manual speech recognition and command execution is realized by a human operator, wherein, due to the manual input into a speech recognition system, new speech models are continuously learnable and linked to corresponding control commands.

12. The method according to claim 11, wherein terminal is actuated via a single operating element and the control center can be thereby contacted.

13. The method according to claim 11, wherein terminal is actuated via a control button and the control center can be thereby contacted.

14. The method according to claim 11, wherein the communication between the user and the control center is carried out via a speech input and output unit of the terminal.

15. The method according to claim 11, wherein the communication between the user and the control center is carried out via a telephone.

16. The method according to claim 11, wherein the human operator comprises a call center.

17. The method according to claim 16, wherein the call center provides to the user at least one of content offerings of third parties or results of a service, in particular speech and/or image and/or video information.

18. The method according to claim 17, wherein the call center provides to the user at least one of speech, image, or video information.

19. The method according to claim 11, wherein the terminal is configured to be linked wirelessly to any household, entertainment, or communication devices, wherein one or more parameters regarding the devices is transmitted to the control center, and wherein the devices are at least one of monitored or controllable via the control center.

20. The method according to claim 11, wherein the terminal is configured to be linked wirelessly to one or more electronic devices, wherein one or more parameters regarding the one or more electronic devices is transmitted to the control center, and wherein the devices are at least one of monitored or controllable via the control center.

21. A device for communication with a terminal available to a user, said communication using the method according to claim 11, said device comprising:
a terminal for data communication, said terminal comprising a display;
a control center with a processor;
means for data storage; and
a data input/output unit having a display,
wherein:
the control center is configured to communicate with the user,
the control center is configured to establish communication between any third party participants on the internet and the user, in such a way that the user communicates with the third parties via the control center,
the communication between the user and the control center is carried out via speech,
in the event of failure of an automated speech recognition mechanism, a manual speech recognition and command execution is realized by a human operator, and
due to the manual input into a speech recognition system, new speech models are continuously learnable and linked to corresponding control commands.

22. The device according to claim 21, wherein said terminal comprises at least one of a camera or a speech input/output unit.

23. The device according to claim 21, wherein the communication between the user and the third party participants and the communication between the user and the control center is established and occurs via the internet.
